(19) United States
(12) Patent Application Publication
(10) Pub. No.: US 2007/0070099 A1
(43) Pub. Date: Mar. 29, 2007

(54) METHODS AND APPARATUS FOR INKJET PRINTING ON NON-PLANAR SUBSTRATES

(76) Inventors: Emanuel Beer, San Jose, CA (US); Chang Tsung Lin, Fremont, CA (US); Shinichi Kurita, San Jose, CA (US); Quanyuan Shang, Saratoga, CA (US); Benjamin Johnston, Los Gatos, CA (US)

Correspondence Address: DUGAN & DUGAN, PC, 55 SOUTH BROADWAY, TARRYTOWN, NY, 10591, US

(21) Appl. No.: 11/536,533

(22) Filed: Sep. 28, 2006

Related U.S. Application Data
(60) Provisional application No. 60/721,741, filed on Sep. 29, 2005.

(51) Int. Cl. B41J 25/308

(52) U.S. Cl. 347/8

(57) ABSTRACT

A sensor apparatus for an inkjet printing device is provided. The sensor apparatus may include 1) at least one print head adapted to deposit ink on a top surface of a substrate, wherein the substrate is in motion relative to the print head, 2) at least one sensor adapted to detect the distance of the at least one sensor from the top surface of the substrate, and 3) a controller adapted to determine the substrate to nozzle distance based on the distance of the sensor to the top surface of the substrate, and adjust the trajectory of the ink being deposited on the substrate based on the substrate to nozzle distance. Numerous other aspects are provided.

### RELATED APPLICATIONS

This applications claims priority to U.S. Provisional Patent Application No. 60/721,741, filed Sep. 29, 2005 and entitled “METHODS AND APPARATUS FOR INKJET PRINTING COLOR FILTERS FOR DISPLAY PANELS” which is hereby incorporated by reference herein in its entirety.

This application is related to U.S. patent application Ser. No. 11/019,930, filed Dec. 22, 2004 and entitled “METHODS AND APPARATUS FOR ALIGNING PRINT HEADS” which is hereby incorporated by reference herein in its entirety.

### FIELD OF THE INVENTION

Embodiments of the present invention generally relate to substrate processing apparatuses and methods, such as apparatuses and methods for flat panel display processing apparatuses (e.g. LCD, OLED, and other types of flat panel displays), semiconductor wafer processing, solar panel processing, etc.

### BACKGROUND OF THE INVENTION

The flat panel display industry has been attempting to employ inkjet printing to manufacture display devices, in particular, color filters on glass or other substrates. Embodiments of the present apparatus and method comprise inkjetting ink or other material accurately and precisely on a moving substrate, that may have imperfections, while maintaining high throughput. Accordingly, methods and apparatus are employed to efficiently and reliably achieve accurate deposition of ink on imperfect substrates.

### SUMMARY OF THE INVENTION

In certain aspects, the present invention provides an apparatus including 1) at least one print head adapted to deposit ink on a top surface of a substrate, wherein the substrate is in motion relative to the print head, 2) at least one sensor adapted to detect the distance of the at least one sensor from the top surface of the substrate, and 3) a controller adapted to determine the substrate to nozzle distance based on the distance of the sensor to the top surface of the substrate, and adjust the trajectory of the ink being deposited on the substrate based on the substrate to nozzle distance.

In other aspects, the present invention provides an apparatus including at least one print head adapted to deposit ink on a top surface of a substrate, wherein the substrate is in motion relative to the print head; at least one sensor adapted to detect a distance of the at least one sensor from the top surface of the substrate; and a controller adapted to determine a substrate to nozzle distance based on the distance of the sensor to the top surface of the substrate and adjust a print parameter based on the substrate to nozzle distance.

In yet other aspects, the present invention provides a method of inkjet printing including sensing a distance from a sensor to a substrate; determining a distance from one or more inkjet print heads to the substrate based on the sensed distance from the sensor to the substrate; and adjusting a print parameter based on the determined distance from the one or more inkjet print heads to the substrate.

In still yet other aspects, the present invention provides a system of inkjet printing including a print bridge; at least one print head coupled to the print bridge and adapted to deposit ink on a top surface of a substrate; a stage positioned beneath the print bridge and the at least one print head and adapted to move the substrate relative to the at least one print head; at least one sensor coupled to the print bridge and adapted to detect a distance of the at least one sensor from the top surface of the substrate; and a controller adapted to determine a substrate to nozzle distance based on the distance of the sensor to the top surface of the substrate and adjust a print parameter based on the substrate to nozzle distance.

Other features and aspects of the present invention will become more fully apparent from the following detailed description, the appended claims and the accompanying drawings.

### BRIEF DESCRIPTION OF THE DRAWINGS

FIG. 1A illustrates a front perspective view of an embodiment of an inkjet printing system according to the present invention.

FIG. 1B illustrates a side view of an embodiment of an inkjet printing system according to the present invention.

FIG. 2 depicts a close-up perspective view of inkjet print heads in an exemplary embodiment of the present invention.

FIG. 3 depicts a close-up perspective view of inkjet print heads in an alternate exemplary embodiment of the present invention.

### DETAILED DESCRIPTION OF THE INVENTION

The present invention provides systems and methods for accurate positioning of ink drops on a substrate using an inkjet printing assembly. The velocity of the substrate may be sufficient such that imperfections in the substrate may affect the accuracy of the inkjet printing. The imperfections in the substrate may include variables such as variations in thickness and flatness of the substrate. Because the pixel features (e.g., pixel wells or the like) into and/or onto which ink may be deposited may be particularly small and the imperfections relative large, the possibility of defects introduced by the inkjet printing process is significant.

According to the present invention, an inspection system capable of detecting variations in the substrate and/or inkjet printing assembly and controlling the inkjet process to ensure positional accuracy of ink deposited on a substrate may be provided in an inkjet printing system. Positional inaccuracy of ink deposited on a substrate may be caused by imperfections of a substrate (e.g., buckling, warping, hills, valleys, etc.), mechanical imperfections in the inkjet printing system, or the like. The sensor system of the present invention may include sensor systems capable of detecting imperfections in the substrate and/or inkjet printing systems. In some embodiments, the sensor system may be capable of providing information to the inkjet printer's controller to allow the controller to compensate for these positional inaccuracies by varying such characteristics as ink drop size, ink drop deposition velocity, ink drop deposition timing, inkjet nozzle/print head displacement and/or alignment, inkjet printing system stage movement, and/or other performance characteristics.

In the same or other embodiments, the apparatus may also include one or more inkjet print heads with nozzles. Range sensors (e.g., distance sensors and the like) may be employed to determine the distance from the nozzle to the top surface of the substrate and/or to other points on the substrate (e.g., the bottom of a pixel or subpixel well). For example, the distance measured by the sensor may be communicated to a controller (e.g., computer running an algorithm or the like) which may analyze the data. Using the analyzed data, the controller may adjust the timing of the ink deposition from the inkjet print head. The timing of the ink deposition may be adjusted by the controller so as to ensure the ink falls into any appropriate pixel well or subpixel well.

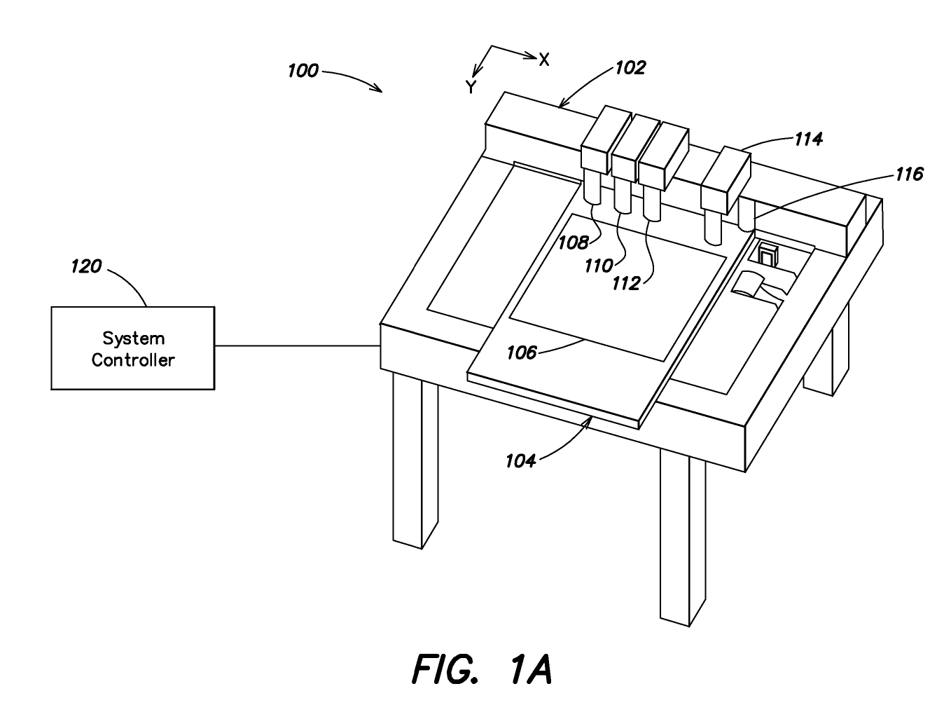

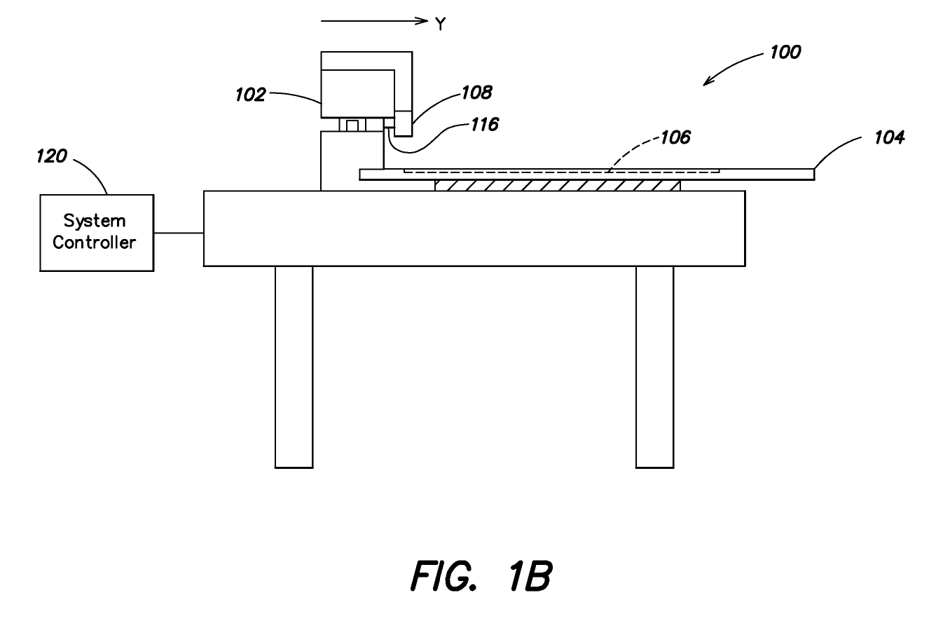

FIGS. 1A and 1B illustrate a front perspective and side view, respectively, of an embodiment of an inkjet printing system 100 of the present invention which is designated generally by reference numeral 100. The inkjet printing system 100 of the present invention, in an exemplary embodiment, may include a print bridge 102. The print bridge 102 may be positioned above and/or coupled to a stage 104. The stage 104 may support a substrate 106. Supported on print bridge 102 may be print heads 108, 110, 112. Print bridge 102 may also support an imaging system 114. Also supported on print bridge 102 may be a sensor 116. Print heads 108-112, imaging system 114, and/or sensor 116, may be coupled (e.g., logically and/or electrically or the like) to a system controller 120.

In the exemplary embodiment of FIGS. 1A and 1B, the print bridge 102 may be supported above the stage 104 in such a manner as to facilitate inkjet printing. The print bridge 102 and/or stage 104 may be movable each independently in both the positive and negative X and Y directions as indicated by the Y direction arrows in FIGS. 1A and 1B and the X direction arrow in FIG. 1A. In the same or alternative embodiments print bridge 102 and/or stage 104 may be rotatable. The print bridge 102 may be capable of supporting and moving any number of print heads 108-112 and/or sensors (e.g., multiple imaging systems 114, multiple sensors 116, etc.). The substrate 106 may sit atop or, in some embodiments, be coupled to the movable stage 104.

Although three print heads 108-112 are shown on print bridge 102 in FIGS. 1A and 1B, it is important to note that any number of print heads may be mounted on and/or used in connection with the print bridge 102 (e.g., 1, 2, 4, 5, 6, 7, etc. print heads). Print heads 108-112 may each be capable of dispensing a single color of ink or, in some embodiments, may be capable of dispensing multiple colors of ink. Inkjet print heads 108-112 may be movable and/or alignable vertically and horizontally so as to enable accurate inkjet drop placement. The movement and/or alignment of the inkjet print heads may be automatic and/or manual. Furthermore, although the orientations of the inkjet print heads 108-112 are depicted oriented in an approximately vertical manner, other orientations and/or positions may be employed. The print bridge 102 may also be movable and/or rotatable to position print heads 104-106 for accurate inkjet printing. In operation, the inkjet print heads 108-112 may dispense ink (e.g., from a nozzle) in drops (e.g., liquid drops, spray, particles or the like).

Imaging system 114 may be directed toward the substrate 106 and may be capable of capturing still and/or moving images of the substrate 106. Exemplary imaging systems for use in an inkjet print system are described in U.S. patent application Ser. No. 11/019,930, filed Dec. 22, 2004 and entitled “METHODS AND APPARATUS FOR ALIGNING PRINT HEADS” which is hereby incorporated by reference herein in its entirety. Similarly, imaging system 114 may include one or more high resolution digital line scan cameras, CCD-based cameras, and/or any other suitable cameras.

Still with reference to FIGS. 1A and 1B, although a single sensor 116 is shown on the print bridge 102, multiple sensors may be coupled to print bridge 102. The sensor 116 may be coupled to the bridge 102 in multiple different ways. For example, multiple sensors 116 may be coupled to the bridge 102 directly and/or via the inkjets 108-112 and/or the imaging system 114. Multiple sensors 116 may be disposed at different locations along print bridge 102. In some embodiments, sensors 116 may be disposed in proximity to the print heads 108-112 such as being located interstitially between the inkjet print heads 108-112 and the bridge 102. Furthermore, although the sensor 116 is depicted oriented in an approximately vertical manner, other suitable orientations and/or positions may be employed.

The sensor 116 may be capable of detecting a range (e.g., distance or the like) from the inkjet print heads 108-112 to the substrate 106. The sensor 116 may also be capable of determining a height (e.g., thickness or the like) of the substrate 106. Furthermore, the sensor 116 may be employed to detect the distance from the sensor 116 and/or one or more nozzles of the print heads 108-112 to a surface of the stage 104 and/or substrate 106 (e.g., the top of the substrate, the bottom of a pixel well, etc.). Sensor 116 may be any suitable sensor capable of performing these and other related functions.

In an illustrative embodiment, a laser sensor may be utilized. The laser sensor may, at a high sampling rate and accuracy, measure the thickness and/or height of the substrate 106 and/or stage 104. Similarly, the laser sensor may measure any other height, such as the distance from the bottom surface of the substrate to the bottom of a pixel or subpixel well.

Examples of commercially available sensors suitable for use as displacement meters/sensors 116 include the ZS-Series Smart Sensor (2D CMOS Laser Type) manufactured by Omron Electronics Pte. Ltd. of Singapore and the LC-series Laser Displacement Meter manufactured by Keyence Corp. of Osaka, Japan. In an alternative embodiment, the sensor 116 may be another sensor or meter type, such as an ultrasonic distance sensor. It is understood that any appropriate device for measuring a height (e.g., vertical displacement) and/or a span distance may be used.

The print bridge 102, stage 104, inkjet print heads 108-112 and/or sensor 116 may be coupled (e.g., digitally, electrically, or the like) to the system controller 120. The system controller 120 may be adapted to control motion of the print bridge 102, the stage 104, inkjet print heads 108-112 and/or sensor 116 in inkjet printing operations. System controller 120 may also control firing pulse signals for inkjet print heads 108-112 and/or perform other controlling functions related to inkjet printing. The system controller 120 may be of any suitable construction such as one or more microprocessors, microcontrollers, dedicated hardware, a combination of the same, and/or the like and may be provided and employed (e.g., programmed) to control operation of the inkjet printing system 100 described herein.

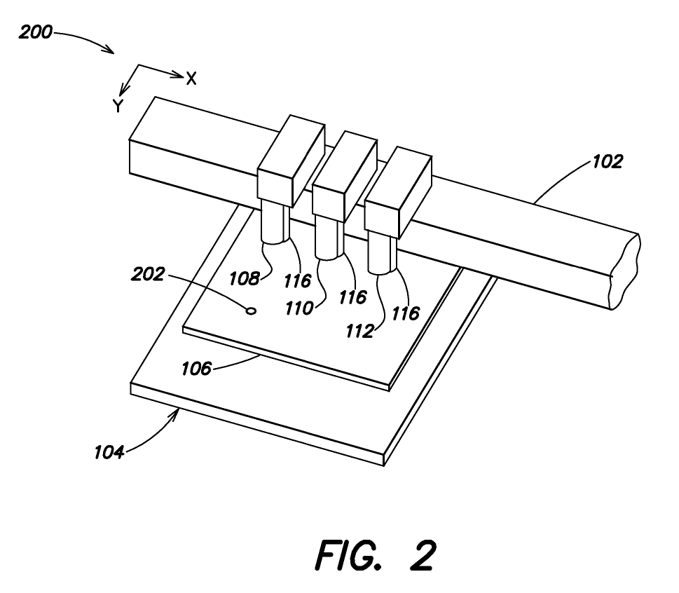

FIG. 2 depicts a close-up perspective view of the inkjet print heads 108, 110, and 112 in an exemplary embodiment of the print system 200 of the present invention. The ink jet print heads 108-112 may be coupled to the print bridge 102. The print bridge 102 may be disposed over the stage 104 and the substrate 106. The substrate 106 may be disposed on the upper surface of the stage 104. The sensors 116 may be disposed in close proximity to the inkjet print heads 108-112. The inkjet print heads 108-112, the print bridge 102, stage 104 and/or sensors 116 may be in communication with the system controller 120. Although sensors 116 are depicted in a position behind print heads 108, 110, 112, relative to the print direction Y, in some embodiments, the sensors 116 may be disposed in alternate locations and orientations. For example, sensors 116 may additionally or alternatively be located in front of and/or adjacent print heads 108-112 relative to the print direction Y. In some embodiments the sensors 116 may be angled so as to detect a distance or height directly below a print head 108-112.

In the embodiment depicted in FIG. 2, the substrate 106 and/or the stage 104 may have imperfections in shape. For example, both the substrate 106 and/or the stage 104 may have undulations so as to affect the flatness of the top surface of the substrate 106. In addition, the print bridge 102 may not be perfectly flat such that the distance between the print heads 108-112 and the substrate 106 may vary as the print heads 108-112 are moved along the print bridge 102. Likewise, the rails (not shown) upon which the stage 104 is moved may not be perfectly flat such that the distance between the print heads 108-112 and the substrate 106 may vary as the stage 104 moves.

Still with reference to FIG. 2, during the inkjet printing process in accordance with an exemplary embodiment, ink drops may be deposited from inkjet print heads 108-112 onto the substrate 106. During the inkjet printing process, the print bridge 102 and/or stage 104 may be in motion. Thus, as the ink drop traverses the distance between the nozzles of the inkjet print heads 108-112 and the top surface of the substrate 106, the resulting ink drop location 202 may be affected by the imperfections in the top surface of the substrate 106. To account for the top surface imperfections of the substrate 106, the system controller 120 may use the information provided by the sensors 116, inkjet print heads 108-112, bridge 102, and/or stage 104 to adjust the trajectory (e.g., timing when the drop is deposited/released, velocity of the ink drop, path of the ink drop, etc.) and/or the size (e.g., volume, shape, distribution, tail, etc.) of the ink drop released from the inkjet print head 110. Thereby, the ink drop location 202 may be placed in the correct location (e.g., pixel well, coordinate on top surface and the like) so as to not introduce defects in the color filter during the printing process. In some embodiments, when adjusting the timing based on distance information, the change in the landing point distance may be determined by the following example equation:
dD=Vₛ*dH/V_{d}
where dD represents the change in landing point distance, Vₛ represents the stage speed, dH represents the change in the substrate height distance, and V_{d} represents the ink drop speed.

In some embodiments, a contour map or profile of the substrate may be stored during one or more initial print passes and then the contour map may be used in subsequent print passes. For example, during a print pass, the system controller 120 may use information provided by the sensors 116, inkjet print heads 108-112, bridge 102, and/or stage 104 to populate a database that represents the relative heights of the substrate surface at different points. In a next print pass the system controller 120 may, for example, make adjustments to the height of the print heads 108-112 based on the information in the database. This information may be used in addition to, or instead of, new information from the sensors 116. In some embodiments, a contour map may be made of the stage alone and may be used with different substrates.

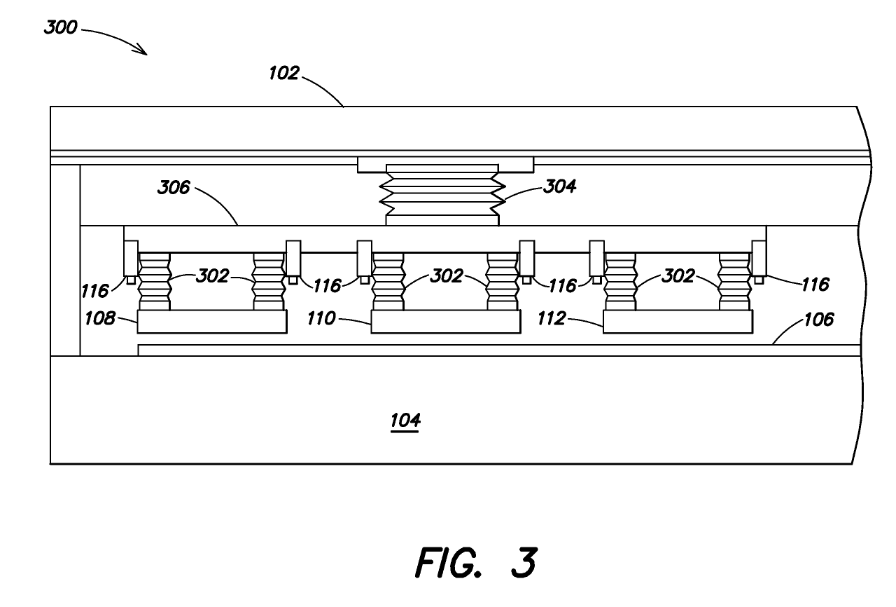

Turning to FIG. 3, in some embodiments, the print system 300 of the present invention may include print heads 108, 110, and 112 mounted to the bridge 102 using an adjustable mounting system. An adjustable mounting system may include one or more actuators 302 for each print head 108-12 that allow the height of the print heads 108, 110, 112 above the surface of the substrate 106 to be individually, independently adjusted during printing. In some embodiments, the height of the print heads 108-112 above the substrate 106 top surface may be maintained at a constant distance during printing by the adjustable mounting system regardless of variations in the thickness or flatness of the substrate. For example, the adjustable mounting system may be coupled directly to the sensors 116 (and/or indirectly through the system controller 120, FIGS. 1A and 1B) to receive sensor to substrate top surface distance information as a feedback signal. The adjustable mounting system may use this feedback signal to adjust the height of the print heads 108-112 to keep the print heads 108-112 at a constant distance from the top surface of the substrate 106 during printing. In other words, if one print head 112 approaches an area of the substrate 106 that is higher than both the area previously printed and the area below the other print heads 108, 110, the sensors 116 can send a feedback signal to the adjustable mounting system actuators 302 (and/or the system controller 120) that causes the adjustable mounting system actuators 302 to raise print head 112 an amount substantially equal to the rise of the higher area of the substrate 106 (while maintaining the height of the other print heads 108, 110). Thus, by dynamically adjusting the height of the print heads 108, 110 and 112 to follow the contours of the substrate 106, a consistent print height may be maintained.

In the same or other embodiments, the print heads 108-112, the print bridge 102, the sensors 116, the controller 120, and the actuators 302 may be used in concert to adjust inkjet timing and/or fine tune drop placement. That is, if one print head (e.g., print head 112) is determined (e.g., by sensors 116 and/or imaging system 114 (FIG. 1A)) to dispense drops of a size and/or velocity that varies from the drops dispensed by the remaining print heads (e.g., print heads 108 and 110) and/or other control over ink drops is necessary, the height of the print head 112 may be adjusted via actuators 302 to cause the print head 112 to dispense ink in a manner substantially similar to print heads 108 and 110. For example, if print head 112 fires sooner than print heads 108 and 110 and approaches an area of the substrate 106 that is higher than both the area previously printed and the area below the other print heads 108, 110, the sensors 116 can send a feedback signal to the adjustable mounting system actuators 302 (and/or the system controller 120) that causes the adjustable mounting system actuators 302 to raise print head 112 higher than an amount substantially equal to the rise of the higher area of the substrate 106 (while maintaining the height of the other print heads 108, 110). In this way, the print heads 108-110 may be moved to cause drops dispensed from some or all of the print heads 108-110 to arrive at the substrate 106 at the same time or at any appropriate spacing to facilitate inkjet printing. Thus, by dynamically adjusting the height of the print heads 108, 110 and 112 to follow the contours of the substrate 106, a consistent print parameter (e.g., height, drop timing, drop size, etc.) may be maintained.

In some embodiments, the actuators 302 may be implemented using motors, pneumatic slides, hydraulic pistons, and/or piezoelectric elements. Further, in addition to individual, independent actuators 302 for each print head 108, 110, and 112, an actuator 304 may be used to adjust the height of all the print heads 108, 110 and 112 at the same time using an additional support 306. In some embodiments, more that one actuator 302 may be used for each print head 108-112. For example, one actuator 302 may be disposed at either end of each print head 108, 110, 112 to allow the heads to be further adjusted/angled to maintain the nozzle to substrate distance. In FIG. 3, an adjustable mounting system includes actuators 302 and 304 and support 306. In other embodiments, the print heads 108-112 may be attached to the bridge 102 with only actuators 302 and without actuator 304 or support 306. In such an embodiment, the adjustable mounting system may only include actuators 302.

The foregoing description discloses only exemplary embodiments of the invention. Modifications of the above disclosed apparatus and method which fall within the scope of the invention will be readily apparent to those of ordinary skill in the art. For instance, an inkjet printing system employing a radial coordinate print bridge combined with ultrasonic sensors may be employed. Further, the present invention may also be applied to spacer formation, polarizer coating, and nanoparticle circuit forming.

Accordingly, while the present invention has been disclosed in connection with exemplary embodiments thereof, it should be understood that other embodiments may fall within the spirit and scope of the invention, as defined by the following claims.

The invention claimed is:

1. An apparatus comprising:
at least one print head adapted to deposit ink on a top surface of a substrate, wherein the substrate is in motion relative to the print head;
at least one sensor adapted to detect a distance of the at least one sensor from the top surface of the substrate; and
a controller adapted to determine a substrate to nozzle distance based on the distance of the sensor to the top surface of the substrate and adjust a print parameter based on the substrate to nozzle distance.

2. The apparatus of claim 1 wherein the at least one sensor is further adapted to detect a thickness of the substrate.

3. The apparatus of claim 1 wherein the at least one sensor is a laser sensor.

4. The apparatus of claim 1 wherein the at least one sensor is an ultrasonic distance sensor.

5. The apparatus of claim 1 further comprising:
one or more actuators coupled to the one or more print heads and adapted to adjust the substrate to nozzle distance.

6. The apparatus of claim 1 wherein the print parameter is a trajectory of an ink drop.

7. The apparatus of claim 1 wherein the print parameter is a velocity of an ink drop.

8. The apparatus of claim 1 wherein the print parameter is a size of an ink drop.

9. The apparatus of claim 1 wherein the print parameter is a coordinate on the top surface of the substrate.

10. The apparatus of claim 1 or claim 5 wherein the print parameter is the substrate to nozzle distance.

11. A method of inkjet printing comprising:
sensing a distance from a sensor to a substrate;
determining a distance from one or more inkjet print heads to the substrate based on the sensed distance from the sensor to the substrate; and,
adjusting a print parameter based on the determined distance from the one or more inkjet print heads to the substrate.

12. The method of claim 11 further comprising detecting a thickness of the substrate with the sensor.

13. The method of claim 11 wherein the at least one sensor is a laser sensor.

14. The method of claim 11 wherein the at least one sensor is an ultrasonic distance sensor.

15. The method of claim 11 further comprising:
adjusting the one or more print heads with one or more actuators coupled to the one or more print heads.

16. The method of claim 11 wherein the print parameter is a trajectory of an ink drop.

17. The method of claim 11 wherein the print parameter is a velocity of an ink drop.

18. The method of claim 11 wherein the print parameter is a size of an ink drop.

19. The method of claim 11 wherein the print parameter is a coordinate on the top surface of the substrate.

20. The method of claim 11 wherein the print parameter is the substrate to nozzle distance.

21. The method of claim 11 further comprising storing a contour map of the substrate.

22. The method of claim 21 further comprising adjusting the one or more print heads based on the contour map.

23. A system for inkjet printing comprising:
a print bridge;
at least one print head coupled to the print bridge and adapted to deposit ink on a top surface of a substrate;
a stage positioned beneath the print bridge and the at least one print head and adapted to move the substrate relative to the at least one print head;
at least one sensor coupled to the print bridge and adapted to detect a distance of the at least one sensor from the top surface of the substrate; and
a controller adapted to determine a substrate to nozzle distance based on the distance of the sensor to the top surface of the substrate and adjust a print parameter based on the substrate to nozzle distance.

24. The system of claim 23 further comprising:
an adjustable mounting system comprising one or more actuators coupled to the one or more print heads and adapted to adjust the substrate to nozzle distance.

25. The system of claim 24 wherein the adjustable mounting system further comprises:
a support actuator coupled to the print bridge;
a support coupled to the support actuator and to the one or more actuators coupled to the one or more print heads, wherein the support actuator is adapted to adjust a substrate to support distance and the one or more actuators coupled to the one or more print heads are adapted to adjust the substrate to nozzle distance of each of the one or more print heads.
